(19) United States
(12) Patent Application Publication
(10) Pub. No.: US 2003/0033139 A1
(43) Pub. Date: Feb. 13, 2003

(54) Method and circuit arrangement for reducing noise during voice communication in communications systems

(75) Inventor: Michael Walker, Lichtenwald (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/200,202

(22) Filed: Jul. 23, 2002

(30) Foreign Application Priority Data
Jul. 31, 2001 (DE) DE 101 37 348.1

(51) Int. Cl. G10L 21/00

(52) U.S. Cl. 704/210; 704/226

(57) ABSTRACT

Such methods are indispensable to ensure natural voice transmission from noisy environments, such as airports or sports arenas, by means of mobile or fixed communications terminals. Noise reduction is also necessary in voice-controlled apparatus to improve the quality of voice recognition. Using a Wiener filter in the well-known spectral subtraction method for noise reduction as well as a compressor and an expander, the dynamic range of the spectral subtraction is extended considerably. By nonlinear control of the overestimation factor and the noise floor of the transfer function of the Wiener filter, in comparison with the known prior art, a qualitative improvement in speech intelligibility is achieved for widely different ratios of speech to noise.

The invention is based on a priority application DE 101 37 348.1 which is hereby incorporated by reference.

### BACKGROUND OF THE INVENTION

This invention relates to a method and a circuit arrangement for reducing noise during voice communication. The use of such a method and such a circuit arrangement is indispensable to ensure natural voice transmission from noisy environments by means of mobile and fixed communications terminals. For example, street noise or noise at airports should not appreciably impair the intelligibility of speech during the use of radiotelephones. The same applies to engine noise during the use of car telephones. In the military area, for instance during voice transmission from tanks, effective noise reduction is indispensable. Further applications are in audio/video conference systems and, to an increasing extent, in voice-controlled apparatus, where speech recognition is an essential quality feature.

A generally known method of noise reduction is linear spectral subtraction. In this method, after transformation of the noisy speech signal from the time domain to the frequency domain using, for example, the fast Fourier transform (FFT), the noise spectrum is determined during speech pauses and, before the speech signal is transformed from the frequency domain back to the time domain using the inverse fast Fourier transform (IFFT), subtracted from the spectrum of the noisy speech signal. The result strongly depends on the accuracy of the determination of the noise spectrum. With a trivial subtraction, good results are achieved in the presence of stationary noise. In practice, however, noise is nonstationary, and various algorithms are used to perform spectral subtraction.

To determine the noise components of a noisy speech signal in the frequency domain, it is generally known to use a Wiener filter. With the Wiener filter, the transfer function H(b,n) of a frequency line n is computed according to Eq. 1. With the fast Fourier transform, n frequency lines are determined by k sample values which are present within a time interval, a block b.

$$H ( b , n ) = \{ \begin{matrix} 1 - {o ( \frac{\vert N L ( b , n ) \vert}{\vert N L ( b , n ) + S ( b , n ) \vert} )}^{2} & i f H ( b , n ) < c \\ c & e l s e\end{matrix} \qquad ( 1 )$$

o=overestimation factor

c=background noise, noise floor

b=time interval, block of the Fourier transform

n=frequency line

NL(b,n)=average noise level

S(b,n)=speech signal

The average noise level is determined by means of a first-order recursive filter.

When using the Fourier transform to transpose the input sample values x(k) to the frequency domain, the input sample values are convolved with the sine and cosine functions of the respective frequency lines n. Sum products are formed over a time interval of, e.g., K=128 sample values, which are then divided by the number K of sample values for normalization. If input signals with a speech signal level of −36 dB, i.e., signal levels from a person speaking in a low voice, are transformed, the individual sample value is divided by K for normalization. Accordingly, the individual sample value is only represented by a level of −76 dB. For economical reasons, most products use 16-bit fixed-point processors, so that a resolution of 96 dB is achieved. In the above example, however, this resolution does not suffice to compute a representative noise level in the frequency domain. Hence, errors occur in the presence of low speech signal levels, so that the method can only be used in a limited dynamic range of the speech. Because of the limited resolution of a fixed-point processor, the speech signal is additionally degraded by noise. As a result of the block-by-block processing of the input sample values x(k) using the fast Fourier transform, the retransformation using the inverse fast Fourier transform provides one value per block, so that a discontinuous sequence of values can result which may be audible as “musical tones” in the retransformed speech signal. To avoid this effect, the noise floor c is chosen to be so high that the “musical tones” are masked. As a result, however, only limited noise reduction, about 6 dB, is attainable with the algorithm described.

Under extreme conditions, linear spectral subtraction has significant drawbacks. At a very low speech-to-noise or signal-to-noise (S/NL) ratio, the speech signal may be significantly degraded if too large an overestimation factor o is chosen. At a very high S/NL ratio, the speech signal is unnecessarily reduced during spectral subtraction.

### SUMMARY OF THE INVENTION

The invention has for its object to provide a method of noise reduction which permits natural speech reproduction even for great variances of the input sample values during voice transmission in communications systems and at a widely varying S/NL ratio.

This object is attained by the method set forth in the first claim and by the circuit arrangement described in the third claim.

The gist of the invention consists in the fact that the input sample value is adapted by compression to the conditions of a fast Fourier transform, and that for the Wiener filtering, nonlinear influence variables are introduced which are controlled by the magnitude of the S/NL ratio.

### BRIEF DESCRIPTION OF THE DRAWINGS

The invention will become more apparent from the following description of an embodiment taken in conjunction with the accompanying drawings, in which:

FIG. 1 is a block diagram of a circuit arrangement for carrying out the method in accordance with the invention; and

FIG. 2 is a plot of the noise floor c and the overestimation factor o as a function of the reciprocal NL/S of the signal-to-noise ratio.

### DESCRIPTION OF PREFERRED EMBODIMENTS

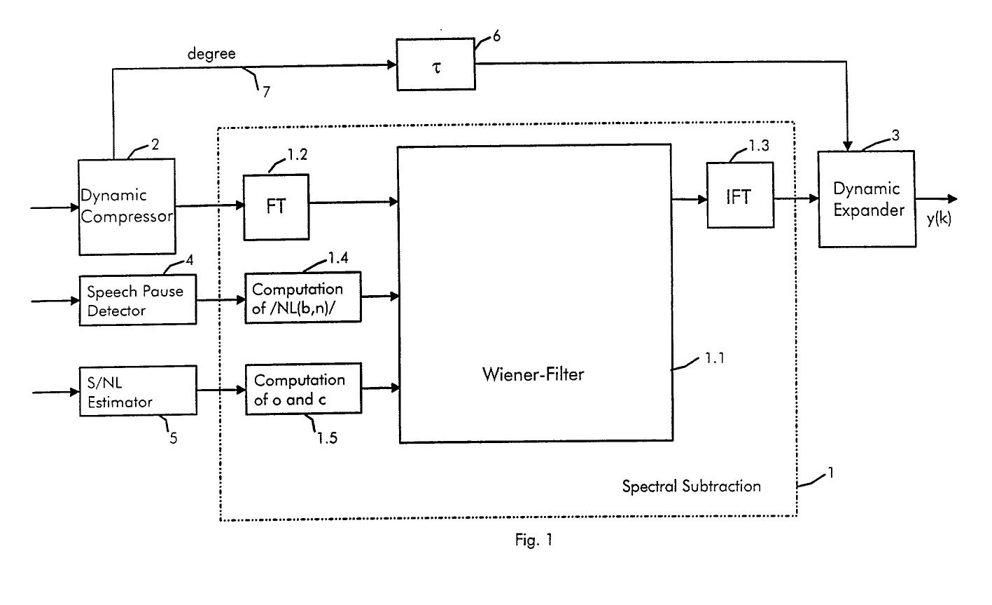

FIG. 1 shows schematically the units which are necessary for an understanding of the invention. According to FIG. 1, the circuit arrangement for carrying out the noise reduction consists essentially of a subcircuit for spectral subtraction 1 which is preceded by a compressor 2, a speech pause detector 4, and a signal-to-noise ratio estimator 5, and which is followed by an expander 3. Compressor 2 and expander 3 are interconnected via a delay element 6 which is inserted in the path 7 for transmitting the reciprocal of the compression ratio from compressor 2 to expander 3. The subcircuit for spectral subtraction 1 consists of a Wiener filter 1.1, a circuit 1.2 for performing the Fourier transform, a circuit 1.3 for performing the inverse Fourier transform, a circuit 1.4 for estimating the noise level NL, and a circuit 1.5 for computing the overestimation factor o and the noise floor c. The input sample value x(k) is first compressed in the time domain by compressor 2. The onset point of compressor 2 is controlled by the noise level NL. The amplitudes of the input sample value x(k) of the noisy speech which lie in the range of the onset point are amplified, and input sample values x(k) which lie above the onset point are regulated back to a nearly constant output voltage of compressor 2. The noisy speech signal is thus amplified to a normalized level, e.g., −16 dB, and then transformed into the frequency domain. In this manner, the levels for the noise NL(b,n) and for the noisy speech signal NL(b,n)+S(b,n), which are easily representable for the computation of the transfer function H(b,n) of the Wiener filter 1.1, are obtained even for very small input sample values x(k).

To be able to perform the spectral subtraction, the estimated averages of the speech signal S(b,n) and the noise NL(b,n) are determined according to Equations 2 and 3 using a first-order recursive filter. With the signal-to-noise ratio estimator 5, the S/NL ratio is then determined. The estimation of the noise NL(b,n) is performed during speech pauses, and that of the speech S(b,n) during speech activity. Speech pause, p=1, and speech activity, p=0, are indicated by the speech pause detector.

$$\begin{matrix}S ( b , n ) = \{ \begin{matrix} α ( n ) \cdot \vert X ( b , n ) \vert + β ( n ) S ( b - 1 , n ) & i f p = 0 \\ S ( b - 1 , n ) & e l s e\end{matrix} & ( 2 ) \\ N L ( b , n ) = \{ \begin{matrix} α ( n ) \cdot \vert X ( b , n ) \vert + β ( n ) N L ( b - 1 , n ) & i f p = 1 \\ N L ( b - 1 , n ) & e l s e\end{matrix} & ( 3 )\end{matrix}$$

After the spectral subtraction, the remaining frequency spectrum is transformed back to the time domain using the inverse Fourier transform 1.3, with the Fourier-transform-induced propagation delay being simulated by the delay element 6 between compressor 2 and expander 3. The original dynamic range of the signal is then restored by means of expander 3, whose output provides the noise-reduced speech signal y(k). The residual noise remaining after the spectral subtraction is reduced by an amount equal to the expansion loss, which is transferred as the reciprocal of the compression ratio over path 7 to expander 3. If the expansion ratio is amplified in the range below the noise threshold, additional noise reduction can be achieved. Experiments have shown that an additional noise reduction by about 12 dB can be achieved without audible speech modulation.

To improve the linear spectral subtraction, nonlinear components are introduced into the transfer function H(b,n) of the Wiener filter, see Eq. 1, so that the noise reduction is adapted to the nonlinear transient response of the human ear, thus permitting natural speech reproduction.

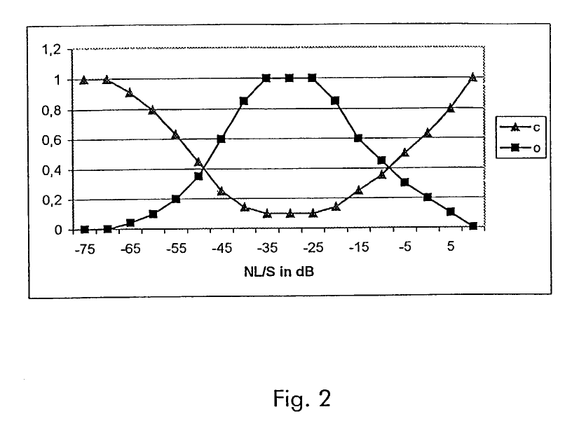

Since a signal-to-noise ratio estimator 5, consisting of a speech level estimator and a noise level estimator, is provided for carrying out the method anyhow, it is possible without an appreciable amount of additional circuitry to determine the overestimation factor o and the noise floor c as a function of the current S/NL ratio as nonlinear influence variables, as shown in FIG. 2. FIG. 2 shows the dependence of the noise floor c and the overestimation factor o on the ratio of noise NL to speech S. The S/NL ratio which is referred to in the following decreases as the noise-to-speech ratio increases.

According to Eq. 1, H(b,n) becomes equal to 1 if NL(b,n)<<S(b,n), i.e., at very high S/NL ratios. In this case, the frequency spectrum remains unchanged, nothing is subtracted from the frequency spectrum, and the overestimation factor o is zero. The overestimation factor a determines the amount of noise reduction during speech activity. According to FIG. 2, the overestimation factor o decreases with decreasing S/NL ratio, as far as reliable separation is possible between noise NL and speech S. At very poor S/NL ratios, the overestimation factor o must be decreased again, because otherwise there is the danger that the speech signal S is adversely affected during spectral subtraction.

Like the overestimation factor o, the noise floor c in Eq. 1 is controlled in accordance with the S/NL ratio. If the noise floor c becomes zero, then H(b,n) can assume the value zero, so that frequency lines are suppressed during transmission. Since errors in the computation of the transfer function H(b,n) of the Wiener filter on the basis of the S/NL ratio are unavoidable, musical tones become audible more loudly as the noise floor c decreases, i.e., the more will be subtracted from the frequency spectrum. At a very good S/NL ratio, c is set equal to 1, i.e., when H(b,n)=1, the frequency spectrum will not be changed. As the S/NL ratio decreases, the noise floor c decreases and the noise suppression increases, namely as far as reliable separation is possible between noise NL and speech S. At a very poor S/NL ratio, the noise floor c must increase again, because otherwise too large a value would be subtracted from the speech-signal spectrum during spectral subtraction. Thus, the noise floor c also becomes a function of the current S/NL ratio. In practice, it is possible to use only the estimated noise level NL to control the noise floor c.

The best results for the transfer function H(b,n) of the Wiener filter 1.1, taking into account the nonlinear control of the overestimation factor o and the noise floor c, are achieved if the two variables are related by the following equation:

$$o ( \frac{S}{N L} ) = \frac{1}{log [ c ( \frac{S}{N L} ) ]} \qquad ( 4 )$$

Slightly altering the circuit arrangement shown in FIG. 1, the speech pause detector 4 may follow the expander 3 at the output of the circuit arrangement.

Depending on the selected compression ratio of compressor 2 and on the selected expansion ratio of expander 3, characteristics with different rates of rise are possible for compressor 2 and expander 3.

Compared to the known prior art, the following advantages are achieved with the invention:

Effect of spectral subtraction over an extended dynamic range

Significant reduction of musical tones

Use of low-cost fixed-point computers

Improved signal-to-noise ratio, no inherent noise

Qualitative improvement in intelligibility for different signal-to-noise ratios

Improved recognition rate in speech recognition systems.

1. A method of reducing noise during voice transmission in communications systems using a Wiener filter for spectral subtraction of a noise spectrum from a spectrum of a noisy speech signal in the frequency domain, the method comprising at least one of the following steps:
compressing the time function of the noisy speech signal with a compressor before transformation to the frequency domain in such a way that independently of the dynamic range of the noisy signal, the transformation to the frequency domain is made possible so that representative noise levels can be computed in the frequency domain, and, after retransformation of the noise-reduced speech signal from the frequency domain to the time domain, undoing the compression of the time function of the noisy speech signal with an expander;
controlling the overestimation factor o in the transfer function H(b,n) of the Wiener filter
$$H ( b , n ) = \{ \begin{matrix} 1 - {o ( \frac{\vert N L ( b , n ) \vert}{\vert N L ( b , n ) + S ( b , n ) \vert} )}^{2} & i f H ( b , n ) < c \\ c & e l s e\end{matrix}$$
in accordance with the ratio of speech signal to noise signal; and
controlling the noise floor in the transfer function of the Wiener filter in accordance with the ratio of speech signal to noise signal.

2. A method as set forth in claim 1, characterized in that the overestimation factor o and the noise floor c have the relationship
$$o ( \frac{S}{N L} ) = \frac{1}{log [ c ( \frac{S}{N L} ) ]}$$

3. A circuit arrangement for carrying out the method set forth in claim 1, characterized in that a compressor is connected ahead of a Wiener filter via a circuit for performing a Fourier transform, that the Wiener filter has its output connected via a circuit for performing an inverse Fourier transform to an expander, that the compressor is connected to the expander via a delay element, and that the input signal to the circuit arrangement is applied to the compressor, to a speech pause detector connected to the Wiener filter via a circuit for estimating the noise level, and to a signal-to-noise ratio estimator connected to the Wiener filter via a circuit for computing the overestimation factor o and the noise floor c.

4. A circuit arrangement as set forth in claim 3, characterized in that the speech pause detector follows the expander.
